(19) United States
(12) Patent Application Publication
(10) Pub. No.: US 2011/0166258 A1
(43) Pub. Date: Jul. 7, 2011

(54) RESIN COMPOSITION FOR NO-FLOW UNDERFILL, NO-FLOW UNDERFILL FLIM USING THE SAME AND MANUFACTURING METHOD THEREOF

(75) Inventors: Seung Woo Hong, Seoul (KR); Woo Seok Kim, Seoul (KR); Ki Jeong Moon, Seoul (KR); Hae Sang Jeon, Seoul (KR)

(73) Assignee: TORAY SAEHAN INC., Gumi-si (KR)

(21) Appl. No.: 12/752,877

(22) Filed: Apr. 1, 2010

(30) Foreign Application Priority Data
Jan. 5, 2010 (KR) 10-2010-00625

(51) Int. Cl. C08L 63/00

(52) U.S. Cl. 523/400

(57) ABSTRACT

Disclosed herein are a resin composition for no-flow underfill, which can be formed into a film, a no-flow underfill film formed from the composition and a manufacturing method of the no-flow underfill film. The resin composition for no-flow underfill has a viscosity higher than 500 cps which is suitable for coating on a film. Thus, the no-flow underfill composition can be manufactured into a laminatable film type without any additional additive. Accordingly, the resin composition makes it possible to accurately control the thickness and area of underfill, unlike the prior paste type composition.

### BACKGROUND OF THE INVENTION

1. Field of the Invention

The present invention relates to a resin composition for no-flow underfill which can be formed into a film, a no-flow underfill film using the composition, and a manufacturing of the no-flow underfill film, more particularly, to a resin composition for no-flow underfill, which comprises a thermoplastic epoxy resin prepolymer, and thus can be formed into a film so as to make it possible to control the thickness and area of underfill, and to no-flow underfill film formed from the resin composition and a manufacturing method of the no-flow underfill film.

2. Description of the Prior Art

In a flip chip package process, in order to solve the mismatch caused by the difference between the coefficients of thermal expansion (CTE) of a semiconductor chip, an interconnection material and a package substrate and to physically support the electrical connection between the package substrate and the semiconductor chip, a sealing material is filled in the gap between the semiconductor chip and the package substrate. This sealing material is known as “underfill” in the art, and the use of the underfill can increase the fatigue life of the solder joints.

As a process for underfilling semiconductor components, a capillary flow underfill process is being mainly used in which a liquid underfill material such as epoxy resin is dispensed between a semiconductor substrate and a package substrate and then cured. In conventional capillary flow underfill, the underfill dispensing and curing takes place after the metallic solder has been reflowed to form interconnections (a soldering process). When a predetermined amount of underfill material is dispensed along one or more peripheral sides of the package assembly, the underfill material is drawn inward by capillary action occurring in the gap between the semiconductor chip and the package substrate. The underfill material dispensed as described above is subsequently cured, thus completing the package assembly.

As a more effective process than that described above, a no-flow underfill process has been proposed. In the no-flow underfill process, underfill resin is applied to the assembly site before the semiconductor chip is placed. After the semiconductor chip is placed on the package substrate, it is soldered to the metal pad connections on the substrate by passing the full assembly, comprising the semiconductor chip, underfill and package substrate, through a reflow oven. During this process, the underfill fluxes the solder and metal pads, the solder joint ref lows, and the underfill cures. Thus, when the above-described no-flow underfill process is used, the separate steps of applying the flux and post-curing the underfill are eliminated.

As soldering and cure of the underfill occur during the same step of the process, maintaining the proper viscosity and cure rate of the underfill material is critical in the no-flow underfill process. The underfill must remain at a low viscosity to allow melting of the solder and the formation of the interconnections. It is also important that the cure of the underfill not be unduly delayed after the cure of the solder. It is desirable that the underfill in the no-flow underfill encapsulation process should not interfere with the melting of the solder and should cure rapidly after the melting of the solder. The underfill preferably has such a viscosity that it can be dispensed by a syringe.

However, the above-described no-flow underfill generally has the following problems. Because the underfill must remain at a low viscosity before cure thereof at the soldering process temperature so as to melt the solder thereby to facilitate the formation of the interconnections, it is generally manufactured as a paste type. If the no-flow underfill is manufactured as a paste type, the fluidity of the paste must be suitably adjusted to control the thickness and area of underfill applied. However, because the resin composition is in a paste state, it is difficult to accurately control the thickness of the paste. Also, because it is very difficult to uniformly treat an amount of the resin composition in the process of applying the composition, the paste type resin is disadvantageous for treating a large-area chip or treating several chips at the same time. Thus, these problems need to be solved.

Meanwhile, if the underfill is manufactured as a film type, it is possible to solve the above-described problems, but there is generally a problem in that it is difficult to form a film from the components of the no-flow underfill resin composition. It has been attempted to increase the film formability of the no-underfill resin composition by adding various thermoplastic resins as resin modifiers to the composition before applying the composition, but in this case, it is difficult to guarantee the stable heat resistance and electrical properties of the composition after the curing process. This is because the added modifiers adversely affect heat resistance and electrical properties compared to epoxy curing agents. Also, the modifiers act as binders in the resin composition to make it difficult to ensure low viscosity in the soldering process.

The present inventors have found that, when a thermoplastic epoxy resin prepolymer is obtained through a curing reaction between an epoxy and a low-temperature curing agent, which have an asymmetrically controlled equivalent ratio, and the obtained prepolymer is added to the formulation of the final resin composition, the film formability of the composition can be increased, thereby completing the present invention.

### SUMMARY OF THE INVENTION

Accordingly, the present invention has been made in view of the problems occurring in the prior art, and it is an object of the present invention to provide a resin composition for no-flow underfill, which can be formed into a film so as to make it easy to control the thickness and area of underfill.

Another object of the present invention is to provide a no-flow underfill film formed from said resin composition.

Still another object of the present invention is to provide a manufacturing method of said no-flow underfill film.

The resin composition for no-flow underfill according to the present invention comprises a thermoplastic epoxy prepolymer, a high-temperature curing agent, a thermoplastic resin modifier and a fluxing agent.

The thermoplastic epoxy prepolymer is preferably obtained by allowing an epoxy resin to react with a low-temperature curing agent at a temperature of 80° C. or below.

The epoxy resin is preferably an aromatic epoxy resin which has at least two epoxy functional groups per molecule and an equivalent weight of 470 g/eq or less.

The low-temperature curing agent is preferably an aliphatic primary amine or aminosiloxane.

The equivalent ratio of the epoxy resin to the reactive hydrogen of the amine group of the low-temperature curing agent is preferably 2 to 10.

The thermoplastic epoxy prepolymer produced by the reaction of the low-temperature curing agent with the epoxy resin has a tertiary amine formed therein.

The resin composition for no-flow underfill may further comprise at least one additive selected from the group consisting of reactive monofunctional epoxy diluents, surfactants, adhesion promoters, inorganic fillers, flame retardants, and ion-trapping agents.

The no-flow underfill film according to the present invention has a layer formed by applying the resin composition for no-flow underfill to a base film.

The manufacturing method of the no-flow underfill film according to the present invention comprises the steps of: allowing an epoxy resin to react with a low-temperature curing agent at a temperature of 80° C. or below so as to obtain a thermoplastic epoxy prepolymer; preparing a resin composition for no-flow underfill by mixing the thermoplastic epoxy prepolymer with a high-temperature curing agent, a thermoplastic resin modifier and a fluxing agent to obtain; and applying the resin composition to a base film.

The resin composition for no-flow underfill has a viscosity higher than 500 cps which is suitable for coating on a film. Thus, the no-flow underfill composition can be manufactured into a laminatable film type without any additional additive. Accordingly, the resin composition makes it possible to accurately control the thickness and area of underfill, unlike the prior paste type composition.

### DETAILED DESCRIPTION OF THE INVENTION

A resin composition for no-flow underfill according to the present invention comprises a thermoplastic epoxy prepolymer, a high-temperature curing agent, a thermoplastic resin modifier and a fluxing agent. Herein, the thermoplastic epoxy prepolymer is obtained by allowing an epoxy resin to react with a low-temperature curing agent at a temperature of 80° C. or below.

As used herein, the term “epoxy resin” which is used to obtain the thermoplastic epoxy prepolymer refers to an oligomeric compound having at least two epoxy functional groups per molecule. The epoxy resin is generally obtained, for example, by reacting epihalohydrin with a organic molecule having at least two —OH functional groups therein. Preferably, it is an aliphatic, alicyclic or aromatic epoxy resin of molecular weight of at least 200 which has a cyclic or linear main chain, in which the epoxy resin has at least two glycidyl groups per molecule. Examples of the epoxy resin include bisphenol-based epoxy resins, such as bisphenol A, F, AD or S, phenol, or cresol novolac type epoxy resins, alicyclic epoxy resins, aliphatic epoxy resins, naphthalene-based epoxy resins, fluorene-based epoxy resins, amide-based epoxy resins, glycidyl ester type epoxy resins, etc. These epoxy resins generally have a glycidyl group at the terminal end of the main chain, but may also be used in the form of epoxy resins obtained by allowing the main chain to react with resins or rubbers of other physical properties, such as epihalohydrin-modified epoxy resins, acryl-modified epoxy resins, vinyl-modified epoxy resins, elastomer-modified epoxy resins, or amine-modified epoxy resins. These epoxy resins may be used alone or in a mixture of two or more.

The epoxy resin preferably has an epoxy equivalent weight of 470 g/eq or less, and more preferably 300 g/eq or less, in order to ensure the glass transition temperature and mechanical strength of the composition after cure. In view of the preferred physical properties of the cured epoxy resin, an aromatic epoxy resin is preferable. As used herein, the term “aromatic epoxy resin” refers to an epoxy resin having an aromatic backbone in the molecule. The aromatic epoxy resin preferably has an equivalent weight of 470 g/eq or less and contains one or more epoxy groups per molecule. These epoxy resins may be used alone or in a mixture of two or more.

Specific examples of such epoxy resins include HP4032 series (Dainipppon Ink & Chemicals, Inc.), Epicoat 807 (Japan Epoxy Resin Co.), Epicoat 828 EL, Epicoat 152 and the like. Elastomer-modified liquid epoxy resins include TSR960 (Dainipppon Ink & Chemicals, Inc.; epoxy equivalent weight: 240; viscosity at 25° C.: 60,000-90,000 cp) and the like.

Meanwhile, the epoxy resin may contain non-glycidyl ether epoxides. Examples of the non-glycidyl ether epoxides include 3,4-epoxycyclohexylmethyl-3,4-epoxycyclohexane carboxylate, which has two epoxide groups which are part of the ring structures, and an ester linkage(ERL4221); vinylcyclohexene dioxide, which has two epoxide groups, one of which is part of a ring structure; 3,4-epoxy-6-methylcyclohexylmethyl-3,4-epoxycyclohexane carboxylate; and dicyclopentadiene dioxide. The non-glycidyl ether epoxide may be used in combination with the glycidylether epoxy.

The low-temperature curing agent which is used to obtain the thermoplastic epoxy prepolymer in the present invention serves to promote curing of the epoxy resin component. Examples of the low-temperature curing agent include aliphatic amines, aromatic amines and aminosiloxanes, which have a primary or secondary amine functional group. Among them, the aliphatic amines or aminosiloxanes are preferably used such that unhindered tertiary amines are easily formed after curing. Primary amines are more preferably used because they induce rapid curing of the composition. More specific examples of the low-temperature curing agent include 1-aminoisopropyl-3-aminopropyl-1,1,3,3-tetramethyldisiloxane.

When the epoxy resin and the low-temperature curing agent are used to synthesize the thermoplastic epoxy prepolymer, the equivalent ratio of the epoxy resin to the reactive hydrogen of the amine group of the low-temperature curing agent is preferably 2 to 10. If the epoxy equivalent ratio is less than 2, the viscosity of the thermoplastic epoxy prepolymer will be excessively increased due to a high degree of cure, and if the epoxy equivalent ratio exceeds 10, an excessively large amount of unreacted epoxy will remain in the thermoplastic epoxy prepolymer composition, and it will be difficult to impart film formability to the composition.

When the epoxy resin and the low-temperature curing agent are allowed to react at a temperature of 80° C. or below for at least 30 minutes, a thermoplastic resin will be produced through the reaction shown in Reaction Scheme 1 below. Reaction Scheme 1 is an example in which bisphenol A type epoxy resin is used.

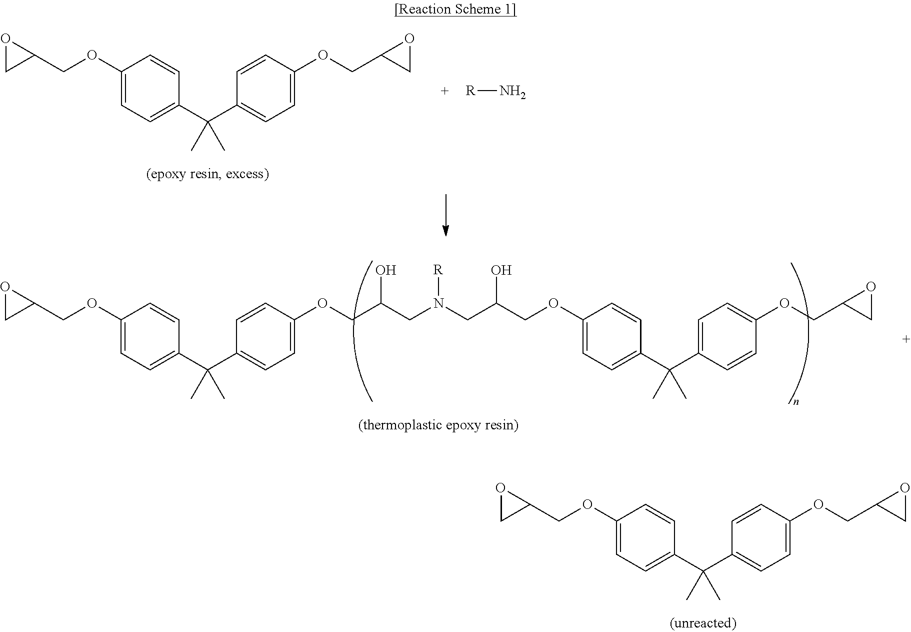

wherein R is an alkyl or siloxane group.

The high-temperature curing agent which is used as one component of the resin composition for no-flow underfill according to the present invention may be a conventional epoxy curing agent, such as an anhydride-based, amine-based or phenol-based curing agent. The high-temperature curing agent is preferably a curing agent which has a curing initiation temperature of 140° C. or above and is rapidly cured in the temperature range from 240 to 250° C. which is the maximum temperature range of the soldering process. Namely, it is preferable that the curing agent be completely cured at the temperature profile of a conventional soldering process. Also, the curing agent preferably has a long pot-life. Specific examples of the high-temperature curing agent include dicyandimides, aromatic diamines, anhydrides such as methylhexahydrophthalic anhydride, and phenol-based curing agents such as phenol novaolac resin or cresol novolac resin. In addition to the curing agent, at least one selected from the group consisting of organic phosphine compounds such as triphenylphosphine, imidazole-based compounds such as 2-ethyl-4-methylimidazole or 2-phenyl-4-methyl-5-hydroxymethylimidazole, and tertiary amines, may be added as a curing accelerator.

The content of the high-temperature curing agent and the curing accelerator is preferably 10-80 parts by weight based on 100 parts by weight of the thermoplastic epoxy prepolymer produced by the reaction of the epoxy rein with the low-temperature curing agent. If the content of the high-temperature curing agent is out of the above range, side reactions other than the curing reaction may occur in the resin composition due to unreacted epoxy or curing agent. Meanwhile, when the curing accelerator is used, it is preferably used in an amount of 0.05-2 parts by weight based on 100 parts by weight of the epoxy resin. If the curing accelerator is used in an amount of less than 0.05 parts by weight, it cannot accelerate the curing reaction, and if it exceeds 2 parts by weight, the curing reaction will rapidly occur, such that it can make it difficult to apply the no-flow underfill to the soldering process and the storage stability of the B-stage product falls down.

Meanwhile, the thermoplastic resin modifier functions to improve the brittle nature of the cured epoxy system so as to increase the fracture toughness of the composition and relax the internal stress. As the thermoplastic resin modifier, general-purpose resins, such as polyester polyol, acrylic rubber, acrylic rubber dispersed in epoxy resins, core-shell rubber, carboxy terminated butadiene nitrile (CTBN), acrylonitrile-butadiene-styrene, or polymethyl siloxane, may be used depending on the properties of the curable resin composition. Preferably, polyester polyol is used, and in this case, it is possible to impart flexibility to the cured composition layer and to increase the curing density of the composition through an additional curing reaction resulting from the hydroxyl group of polyol.

Core-shell rubber particles are rubber particles having a core layer and a shell layer, and examples thereof include: a two-layer structure comprising an outer shell layer made of a glassy polymer, and an inner core layer made of a rubbery polymer; and a three-layer structure comprising an outer shell layer made of a glassy polymer, a middle layer made of a rubbery polymer, and a core layer made of a glassy polymer. The glassy layer is made of, for example, a methyl methacrylate polymer, and the rubbery polymer layer is made of, for example, a butyl acrylate polymer. When the thermoplastic resin modifier is added, it is preferably used in an amount of 0.1-20 parts by weight based on 100 parts by weight of the thermoplastic epoxy prepolymer. If the thermoplastic resin modifier is used in an amount of less than 0.1 parts by weight, it will be difficult to achieve the purpose of increasing the fracture toughness of the resin composition and relaxing the internal stress of the composition, and if it exceeds 20 parts by weight, the content of the curable components in the resin composition can be excessively reduced, the mechanical and electrical reliability of the resin composition can be deteriorated after cure.

The fluxing agent functions to maintain the fluidity of the underfill resin composition at a high level, such that the cure of the resin composition and the electrical connection by a solder joint simultaneously occur in a no-flow underfill process. In addition, the fluxing agent must have a minimized adverse effect on the cure of the underfill composition and, at the same time, remove metal oxides generated in a copper pad on a package substrate during a soldering process and prevent a solder from melting by a re-oxidation reaction during a high-temperature process.

In general, in order to prevent boiling at high temperature, organic compounds having a terminal hydroxyl group, such as organic acids or alcohols, which have low vapor pressure at the soldering process temperature, may be used as the fluxing agent. However, because most organic acids can additionally participate in the curing reaction of the epoxy curing agent system, an organic acid having low reactivity must be selected. Specific examples of the fluxing agent include ethylene glycol, glycerol, 3-[bis(glycidyloxymethyl)methoxy]-1,2-propanediol, glutaric acid, trifluoroacetate and the like. The fluxing agent is preferably used in an amount of 1-10 parts by weight, and more preferably 2-8 parts by weight, based on 100 parts by weight of the total amount of the thermoplastic epoxy prepolymer, the high-temperature curing agent, the curing accelerator and the thermoplastic resin modifier. If the fluxing agent is used in an amount of less than 1 part by weight, it will be difficult to impart a fluidity suitable for a solder joint to the underfill resin composition, and if it is used in an amount of more than 10 parts by weight, it will interfere with the cure of the underfill resin composition, and unreacted fluxing agent can be volatilized during a soldering process.

In addition to the above-described components of the underfill resin composition, additional additives may be used if necessary. For example, when a monofunctional reactive diluent is used, it can delay the increase in the viscosity of the composition without adversely affecting the physical properties of the cured underfill. Examples of the diluent which can be used in the present invention include aliphatic glycidyl ether, allylglycidyl ether, glycerol diglycidyl ether, and mixtures thereof.

Meanwhile, various surfactants may be added in order to suppress the occurrence of voids during a flip-chip bonding process and a soldering process and to increase the fluidity of the underfill composition. Preferred examples of the surfactant include organic acrylic polymers, polymeric siloxanes such as polyol, and fluorine-based compounds such as FC-430 (3M). The surfactant is preferably added in an amount of 0.01-2 parts by weight of the total amount of the thermoplastic epoxy prepolymer, the high-temperature curing agent, the curing accelerator and the thermoplastic resin modifier.

Also, an adhesion promoter may be added to the underfill composition in order to improve the interfacial adhesion between a chip and a package substrate. Examples of the adhesion promoter which can be used in the present invention include imidazole, thiazole, trizole or silane coupling agents. The adhesion promoter is preferably used in an amount of 0.01-2 parts by weight based on 100 parts by weight of the thermoplastic epoxy prepolymer.

Moreover, inorganic filler such as silica, alumina, barium sulfate, talc, clay, aluminum hydroxide, magnesium hydroxide, silicon nitride or boron nitride may be added to the underfill composition in order to control the viscosity and fluidity properties of the underfill composition. In addition, a flame retardant, an ion-trapping agent or the like may be added depending on the intended use of the underfill composition.

According to the present invention, the thermoplastic epoxy prepolymer obtained as described above has formed therein a tertiary amine which can act as a catalyst in the esterification of epoxy. Accordingly, when the resin composition for no-flow underfill according to the present invention is cured at high temperature, the high-temperature curing agent and the epoxy react with each other, while the hydroxyl group and the epoxy is induced as shown in Reaction Scheme 2 below, thus increasing the curing density of the composition. As a result, it is possible to obtain higher heat resistance and mechanical strength.

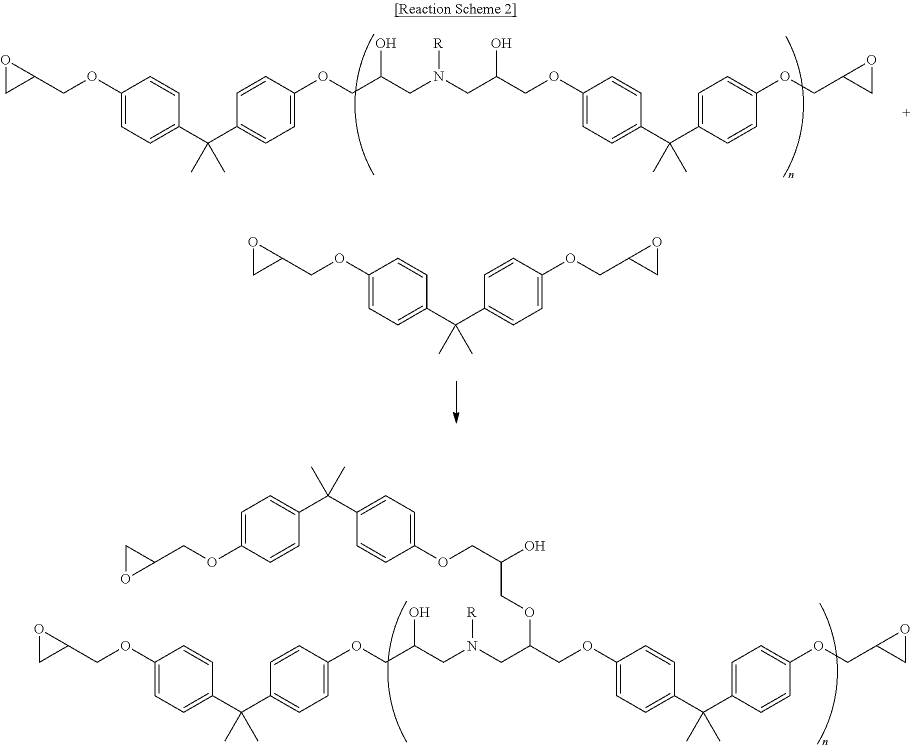

The manufacturing method of the no-flow underfill film according to the present invention comprises the steps of: allowing an epoxy resin to react with a low-temperature curing agent at a temperature of 80° C. or below so as to obtain a thermoplastic epoxy resin; preparing a resin composition for no-flow underfill by mixing the thermoplastic epoxy prepolymer with a high-temperature curing agent, a thermoplastic resin modifier and a fluxing agent; and applying the resin composition to a base film.

According to the present invention, a no-flow underfill film of B-stage is manufactured by applying the underfill resin composition of the present invention to a support base film to form a resin composition layer, and if necessary, drying the layer. In one embodiment, the epoxy resin and the low-temperature curing agent are stirred at a temperature of 80° C. or below for at least 30 minutes to obtain a varnish of a thermoplastic epoxy prepolymer. Then, the thermoplastic epoxy prepolymer varnish is mixed together with a high-temperature curing agent, a thermoplastic resin modifier, a fluxing agent and other necessary additives at room temperature for at least 4 hours to prepare a resin varnish for no-flow underfill.

In the steps of obtaining the thermoplastic epoxy prepolymer or in the process of preparing the resin varnish for no-flow underfill, an organic solvent may be used such that a blend of various components is easily obtained. Examples of the organic solvent which can be used in the present invention include conventional solvents, for example, ketones such as acetone, methyl ethyl ketone or cyclohexanone; acetic acid esters such as ethyl acetate, butyl acetate, cellosolve acetate or propylene glycol monomethyl ether acetate; and aromatic hydrocarbons such as toluene or xylene. These solvents may be used alone or in a mixture of two or more. The resin varnish for no-flow underfill is applied on a base film as a support, and then, if necessary, heated or dried to remove volatile matter such as water, which can result from moisture absorption, thereby forming a resin composition layer.

If necessary, the content of volatile matter which can result from, for example, moisture absorption, is preferably reduced to less than 0.2 wt %, and more preferably 0.15 wt %, through low-temperature aging after the coating process. The low-temperature aging condition is below 80° C., and more preferably below 60° C. The preferred volatile matter content may be achieved by pre-heating after laminating the no-flow underfill film on a package substrate. The pre-heating temperature and time can be controlled in consideration of the thickness and structure of the laminated no-flow underfill film and the package substrate. Preferably, the pre-heating is carried out at a temperature of 100° C. or below for 10 minutes or less.

Examples of the support base film of the no-flow underfill film according to the present invention include: polyolefin such as polyethylene or polyvinyl chloride; polyester such as polyethylene terephthalate; polycarbonate; and release paper. The thickness of the support base film is generally in the range from 10 μm to 150 μm. The support base film is treated by a mud process, a corona process or a release process.

The thickness of the no-flow underfill film according to the present invention can be controlled depending on the gap between a package substrate and a semiconductor chip and is generally in the range from 5 μm to 150 μm.

The inventive no-flow underfill film, which comprises the resin composition layer for no-flow underfill and the support base film, can be stored without further treatment or stored after depositing a protective film on the other surface of the resin composition and then winding the resultant structure. Examples of such a protective film include: polyolefin such as polyethylene or polyvinyl chloride; polyester such as polyethylene terephthalate; polycarbonate; and release paper. The thickness of the support base film is generally in the range from 10 μm to 150 μm.

The support base film can be satisfactorily treated by a mud process, a corona process and a release process. Because the resin of the resin composition for no-flow underfill leaks out in the laminating process, it is advantageous to place the uncoated portion (about 5 mm or longer) of the support base film on one or both sides of the roll, thereby preventing flow of the resin and facilitate the release of the protective film and the support base film.

Hereinafter, the present invention will be described in further detail with reference to examples. It is to be understood, however, that these examples are for illustrative purposes and are not to be construed to limit the scope of the present invention.

### Example 1

### 1. Formulation of Resin Composition for No-Flow Underfill

(1) Obtaining thermoplastic epoxy prepolymer

a) Epoxy resin: 100 g of a 2:1 (wt/wt) blend of bisphenol F epoxy resin (liquid; epoxy equivalent weight: 190) and bisphenol A epoxy resin A (liquid; epoxy equivalent weight: 250).

b) Low-temperature curing agent: 6.0 g of 1-aminoisopropyl-3-aminopropyl-1,1,3,3-tetramethyldisiloxane.

The epoxy resin and the low-temperature curing agent were stirred at 70° C. for 2 hours to obtain a thermoplastic epoxy prepolymer. 100 g of the thermoplastic epoxy prepolymer was used to a resin composition for no-flow underfill.

(2) High-temperature curing agent and curing accelerator: 20.0 g of a 1000:1 (wt/wt) blend of methylhexahydrophthalic anhydride and 2-phenyl-4-methyl-5-hydroxymethylimidazole.

(3) Thermoplastic resin modifier: 10.0 g of polyester polyol.

(4) Fluxing agent: 5.0 g of glycerol.

(5) Additional additive: 0.2 g of FC4430 (3M, surfactant).

The thermoplastic epoxy prepolymer (1), the high-temperature curing agent and curing accelerator (2), the thermoplastic resin modifier (3), the fluxing agent (4) and the additional additive (5) were mixed at room temperature for 4 hours, thus preparing a resin composition for no-flow underfill films.

### 2. Assessment of Composition

1) DSC Analysis

The above-described resin composition was stirred, and then cured by heating, while the curing initiation temperature, the curing peak temperature and the curing heat were measured by Differential Scanning calorimetry (DSC). The measurement was carried out using a DSC instrument (NETZSCH, Model DSC 200 F3 Maia) at a heating rate of 20° C./min.

2) Measurement of Grass Transition Temperature, Coefficient of Thermal Expansion and Heat Resistance Properties

The glass transition temperature (Tg) and thermal expansion coefficient (CTE1 before Tg and CTE2 after Tg) of a sample obtained by curing the composition at 175° C. for 2 hours were measured using a thermal mechanical analyzer ((TA Instruments, Model TMA 2920). Also, a sample obtained by curing the composition in the same conditions as described above was measured for heat resistance properties (weight loss (%) at 300° C., and temperature at 5% weight loss) in a nitrogen atmosphere using a thermogravimetric analyzer (NETZSCH, Model TG 209 F3 Tarsus).

3) Measuring Solderability

In order to examine whether the composition had the ability of a fluxing solder, 0.2 g of the composition was dispensed on a copper specimen, and solder balls (Sn/Ag/Cu; melting point: 217-219° C.) were dropped onto the composition. Then, a glass cover slide was placed on the composition, and the copper specimen was placed on a hot plate preheated to 145° C. After 2 minutes, the copper specimen was immediately transferred onto another hot plate preheated to 230-335° C. and maintained thereon for 2 minutes. Whether the lead-free solder was soldered to the copper specimen was observed with a microscope to evaluate the results of the fluxing test.

The results of the above assessments are summarized in Table 1 below.

TABLE 1

| | Items analyzed | Results |
|---|---|---|
| Differential scanning | DSC initiation temperature (° C.) | 145 |
| calorimetric analysis | DSC peak temperature (° C.) | 195 |
| Solderability | Solder flux | Soldered |
| Thermal mechanical | Tg (° C.) of cured composition | 120 |
| analysis | CTE1 of cured composition(ppm) | 85 |
| | CTE2 of cured composition(ppm) | 170 |
| Thermogravimetric | Weight loss at 300° C. | 1.80 |
| analysis | Temperature at 5% weight loss | 352 |

As can be seen in Table 1 above, at a temperature lower than the soldering temperature, the cure of the composition was suppressed, whereas at the soldering process temperature, the curing reaction of the composition occurred. In addition, during the curing reaction, the composition was maintained at a low temperature such that it could be soldered.

### 3. Examination of Film Formability

A varnish resin obtained by mixing the resin composition of Example 1 had a viscosity of 15,000 cps, as measured with a Brookfield viscometer at room temperature. The resin was applied on a 38-μm-thick PET film by a roll coater such that the film thickness after drying was 60 μm. The applied resin was dried at 80° C. for 10 minutes, thus obtaining an adhesive film. As a result, it could be seen that the resin composition of Example 1 could provide a film having a smooth surface.

As described above, the no-flow underfill film can be used as a sealing material which is filled into the gap between a semiconductor chip and a package substrate.

Although the preferred embodiments of the present invention have been described for illustrative purposes, those skilled in the art will appreciate that various modifications, additions and substitutions are possible, without departing from the scope and spirit of the invention as disclosed in the accompanying claims.

1. A resin composition for no-flow underfill comprising a thermoplastic epoxy prepolymer, a high-temperature curing agent, a thermoplastic resin modifier and a fluxing agent.

2. The resin composition of claim 1, wherein the thermoplastic epoxy prepolymer is obtained by allowing an epoxy resin to react with a low-temperature curing agent at a temperature of 80° C. or below.

3. The resin composition of claim 2, wherein the epoxy resin is an aromatic epoxy resin which has at least two epoxy functional groups per molecule and an equivalent weight of 470 g/eq or less.

4. The resin composition of claim 2, wherein the low-temperature curing agent is an aliphatic primary amine or aminosiloxane.

5. The resin composition of claim 2, wherein the equivalent ratio of the epoxy resin to the reactive hydrogen of the amine group of the low-temperature curing agent is 2 to 10.

6. The resin composition of claim 2, wherein the thermoplastic epoxy prepolymer produced by the reaction of the low-temperature curing agent with the epoxy resin has a tertiary amine formed therein.

7. The resin composition of claim 1, further comprising at least one additive selected from the group consisting of reactive monofunctional epoxy diluents, surfactants, adhesion promoters, inorganic fillers, flame retardants, and ion-trapping agents.

8. A no-flow underfill film comprising a layer formed by applying a resin composition for no-flow underfill to a base film; wherein the resin composition for no-flow underfill comprises a thermoplastic epoxy prepolymer, a high temperature curing agent, a thermoplastic resin modifier and a fluxing agent.

9. A manufacturing method of a no-flow underfill film comprising the steps of:
allowing an epoxy resin to react with a low-temperature curing agent at a temperature of 80° C. or below so as to obtain a thermoplastic epoxy prepolymer;
preparing resin composition for no-flow underfill by mixing the thermoplastic epoxy prepolymer with a high-temperature curing agent, a thermoplastic resin modifier and a fluxing agent; and
applying the resin composition to a base film.

10. The no-flow underfill film of claim 8, wherein the resin composition for no-flow underfill further comprises at least one additive selected from the group consisting of reactive monofunctional epoxy diluents, surfactants, adhesion promoters, inorganic fillers, flame retardants, and ion-trapping agents.

11. The no-flow underfill film of claim 8, wherein the thermoplastic epoxy prepolymer is obtained by allowing an epoxy resin to react with a low-temperature curing agent at a temperature of 80° C. or below.

12. The no-flow underfill film of claim 11, wherein the epoxy resin is an aromatic epoxy resin which has at least two epoxy functional groups per molecule and an equivalent weight of 470 g/eq or less.

13. The no-flow underfill film of claim 11, wherein the low-temperature curing agent is an aliphatic primary amine or aminosiloxane

14. The no-flow underfill film of claim 11, wherein the equivalent ratio of the epoxy resin to the reactive hydrogen of the amine group of the low-temperature curing agent is 2 to 10.

15. The no-flow underfill film of claim 11, wherein the thermoplastic epoxy prepolymer produced by the reaction of the low-temperature curing agent with the epoxy resin has a tertiary amine formed therein.
